(19) United States
(12) Patent Application Publication
(10) Pub. No.: US 2008/0240852 A1
(43) Pub. Date: Oct. 2, 2008

(54) Maintaining Device For Fixing A Motor Vehicle Assembly

(76) Inventors: Andreas Weh, Sulzberg (DE); Nathan McCormick, Advance, NC (US)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/088,251

(22) PCT Filed: Sep. 21, 2006
(86) PCT No.: PCT/EP2006/066589

§ 371 Date: Mar. 27, 2008

(30) Foreign Application Priority Data
Oct. 4, 2005 (DE) 102005047356.3

(51) Int. Cl. F16B 5/02

(52) U.S. Cl. 403/388

(57) ABSTRACT

The invention relates to a maintaining device which comprises a nut a bolt and a damping element, which secures a housing of motor vehicle assembly to a maintaining element. According to the invention, the nut, the bolt and the damping element are premounted as a pre-assembly, which can be inserted into a pre-prepared hole in the housing of the motor vehicle assembly. The damping element, which is arranged in the housing of the motor vehicle assembly, supports the bolt.

### PRIOR ART

The invention is based on a holding device for fastening a vehicle component as generically defined by the independent claim 1.

FIG. 4 shows a know holding device in a motor vehicle for fastening a housing 20 of a hydraulic unit to a holder 30. As is clear from FIG. 4, the conventional holding device has a nut 2, a bolt 4, an elastic damping element 6, and a stop sleeve 8; the bolt 4 is press-fitted with a powerful press-fitting force into a bore in the housing 20 and the elastic damping element 6 is slid onto the bolt 4 in a movable fashion. FIG. 4A shows the conventional holding device in an initial position, i.e. the nut 2 has only been placed onto the bolt 6 and not tightened. FIG. 4B shows the holding device in the fastened state, i.e. the nut 2 has been tightened with a torque and the stop sleeve 8 has squeezed the elastic damping element 8 until the stop sleeve 8 has reached its stop. When the nut 2 is tightened, the hydraulic unit 20 moves in the direction of the arrow and is fastened to the holder 30 by the torque exerted.

### ADVANTAGES OF THE INVENTION

The holding device according to the present invention, with the defining characteristics of the independent claim 1, has the advantage over the prior art that the essential components of the holding device, such as a nut, a bolt, and an elastic damping element are preassembled as a composite unit that can be inserted into a prepared bore in the housing of a vehicle component. Since the elastic damping element supported by the bolt, after insertion into the prepared housing bore, is accommodated completely inside the vehicle component, the damping of structure-borne noise is improved and the resonance is reduced. In addition, the preassembled composite unit advantageously results in shorter assembly times during installation in the vehicle and thus results in lower production costs. Since the holding device according to the invention can be attached to the housing of the vehicle component with lower press-fitting forces than conventional holding devices, the holding device according to the invention can be adapted on-site to various holders used by the customer.

Advantageous improvements of the holding device disclosed in the independent claim are possible by means of the steps and modifications carried out in the dependent claims.

It is particularly advantageous that the bolt is embodied with a recess, which produces a form-locked engagement with the damping element that is mounted onto it. This advantageously prevents the mounted damping element from slipping off.

In order to prevent the sealing element from slipping as it is being inserted into the prepared bore, a stop collar for the sealing element is advantageously formed onto the bolt.

In order to caulk the composite unit to the housing, the housing material around the bore is embodied as plastically deformable so that upon insertion of the composite unit into the prepared bore, an axial fixing can be advantageously implemented without additional parts. In addition, the use of the plastically deformable material makes it possible to use lower press-fitting forces.

For example, the plastic deformation of the housing material and hence the corresponding form-locked engagement is produced in segments or over an entire ring.

The holding device according to the invention can be used, for example, to attach a vehicle component embodied in the form of a hydraulic unit, preferably a hydraulic pump, to a holder embodied, for example, in the form of a mounting bracket or support angle.

### DRAWINGS

The drawings show advantageous exemplary embodiments of the invention described below and also show the conventional exemplary embodiment, which is explained above for better comprehension of the invention.

FIG. 1 shows perspective schematic views of individual components and of a composite unit of a holding device according to the invention,

FIG. 2 is a longitudinal section through the holding device according to the invention,

FIG. 3 is a perspective depiction of a vehicle component with the holding device according to the invention, and

FIG. 4 shows perspective views of a conventional holding device for a vehicle component.

### DESCRIPTION

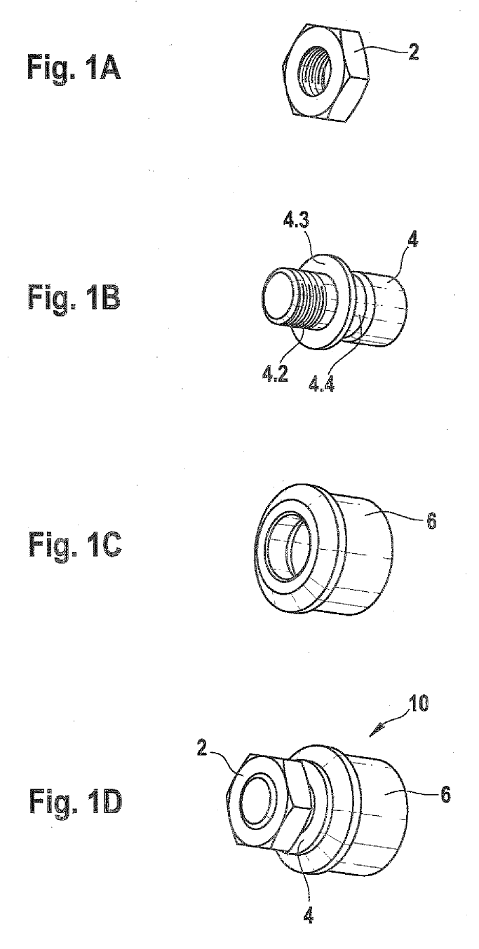

As is clear from FIG. 1, the holding device according to the invention has a nut 2 shown in FIG. 1A, a bolt 4 shown in FIG. 1B, and a damping element 6 shown in FIG. 1C, which are preassembled to form a composite unit 10 shown in FIG. 1D. For the preassembly, the bolt 4 is provided with a recess 4.4, which produces a form-locked engagement with the damping element 6 that is mounted on it, thus preventing the damping element 6 from slipping off the bolt 4. In addition, the nut 2 is screwed onto a threaded part 4.2 of the bolt 4. In order to prevent the sealing element 6 from slipping during insertion into a prepared bore 22, a stop collar 4.3 for the sealing element 6 is formed onto the bolt 4.

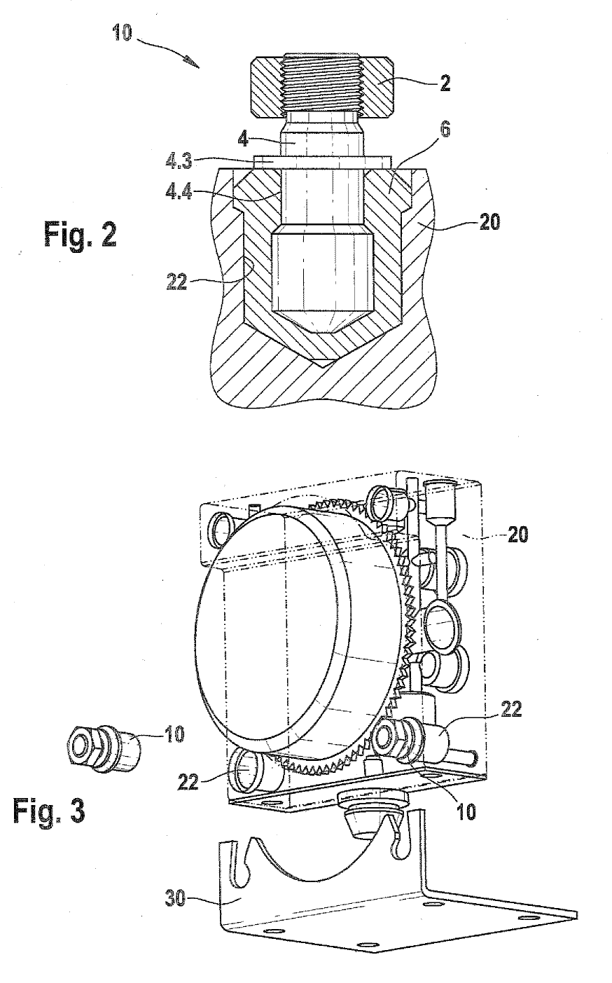

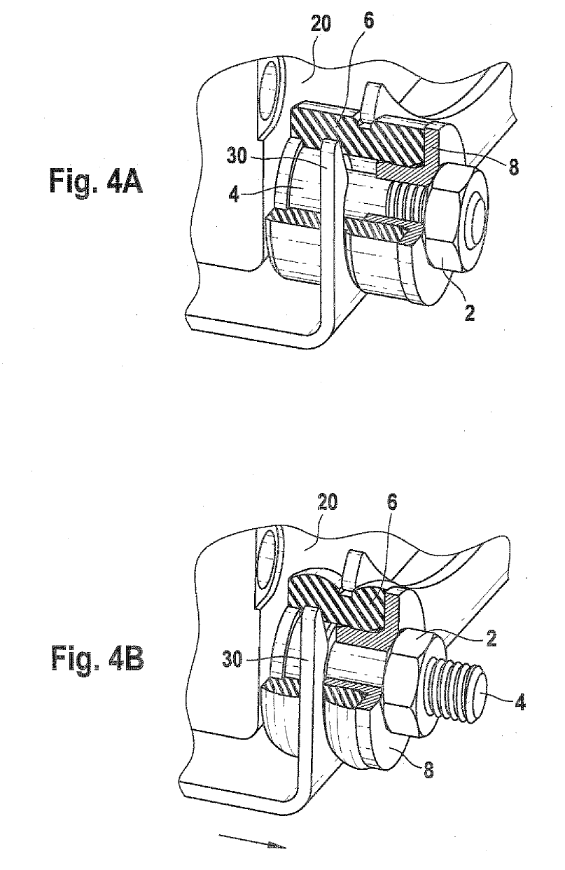

FIG. 2 shows the composite unit 10 inserted into a prepared bore 22 in the housing 20 of a vehicle component. As is clear from FIG. 2, the damping element 6 mounted on the bolt 4 in the exemplary embodiment is accommodated completely inside the bore 22 in the housing 20 of the vehicle component to be attached. Upon insertion of the composite unit 10, the housing material around the bore 22 is plastically deformed into the bore 22, thus caulking and axially securing the composite unit 10 in relation to the housing 20. In the exemplary embodiment shown, the plastic deformation of the housing material and hence the corresponding form-locked engagement is produced in segments.

In an alternative embodiment, not shown, of the holding device according to the invention, the plastic deformation of the housing material and hence the corresponding form-locked engagement is produced over a complete ring.

FIG. 3 is a perspective depiction of a vehicle component 20 embodied in the form of a hydraulic pump. The hydraulic pump 20 shown is attached to a holder 30 by means of two composite units 10 according to the invention, which are inserted into prepared bores 22 provided in the housing 20. In the depiction according to FIG. 3, a first composite unit 10 has already been inserted into a corresponding bore 22 in the right side of the housing 20 of the hydraulic pump, while a second composite unit 10 has not yet been inserted into the corresponding bore 22 in the left side of the housing 20. After insertion of the composite units 10 into the corresponding bores 22 in the housing 20 of the hydraulic pump, the housing 20 is guided by inserting the part of the bolts 4, which protrude out from the edge of the housing, into corresponding guide slots of the holder 30 and is attached to the holder 30 by tightening the nuts, which have been placed onto the threaded part 4.2 of the respective bolts, with a predetermined torque.

The holding device according to the invention, equipped with a damping element accommodated in the housing, can replace the conventional holding device, which has a press-fitted bolt with a damping element mounted onto it, thus improving the damping of structure-borne noise and reducing the resonance. In addition, the collar formed onto the bolt makes it possible to eliminate the stop sleeve. The composite unit according to the invention advantageously includes all parts, including the nut as the fastening element, that are required to attach the hydraulic unit to this corresponding holder, thus making it possible to shorten assembly time and reduce production costs.

1-7. (canceled)

8. In a holding device for attaching a vehicle component to a holder, the holding device having a nut, a bolt, and a damping element, the improvement wherein the nut, the bolt, and the damping element are preassembled to form a composite unit which is insertable into a prepared bore in a housing of the vehicle component, with the bolt supporting the damping element to be accommodated inside the housing of the vehicle component.

9. The holding device according to claim 8, wherein the bolt comprises a recess which produces a form-locked engagement with the damping element that is mounted on it.

10. The holding device according to claim 8, wherein the bolt further comprises a stop collar formed thereon for the damping element.

11. The holding device according to claim 9, wherein the bolt further comprises a stop collar formed thereon for the damping element.

12. The holding device according to claim 8, wherein the housing material surrounding the bore is plastically deformable during insertion of the composite unit, thus permitting the composite unit to be caulked to the housing.

13. The holding device according to claim 9, wherein the housing material surrounding the bore is plastically deformable during insertion of the composite unit, thus permitting the composite unit to be caulked to the housing.

14. The holding device according to claim 10, wherein the housing material surrounding the bore is plastically deformable during insertion of the composite unit, thus permitting the composite unit to be caulked to the housing.

15. The holding device according to claim 11, wherein the housing material surrounding the bore is plastically deformable during insertion of the composite unit, thus permitting the composite unit to be caulked to the housing.

16. The holding device according to claim 12, wherein the plastic deformation of the housing material and hence the corresponding form-locked engagement is producible in segments.

17. The holding device according to claim 13, wherein the plastic deformation of the housing material and hence the corresponding form-locked engagement is producible in segments.

18. The holding device according to claim 14, wherein the plastic deformation of the housing material and hence the corresponding form-locked engagement is producible in segments.

19. The holding device according to claim 15, wherein the plastic deformation of the housing material and hence the corresponding form-locked engagement is producible in segments.

20. The holding device according to claim 12, wherein the plastic deformation of the housing material and hence the corresponding form-locked engagement is producible over a complete ring.

21. The holding device according to claim 13, wherein the plastic deformation of the housing material and hence the corresponding form-locked engagement is producible over a complete ring.

22. The holding device according to claim 14, wherein the plastic deformation of the housing material and hence the corresponding form-locked engagement is producible over a complete ring.

23. The holding device according to claim 15, wherein the plastic deformation of the housing material and hence the corresponding form-locked engagement is producible over a complete ring.

24. The holding device according to claim 8, wherein the vehicle component is embodied in the form of a hydraulic unit, preferably a hydraulic pump.

25. The holding device according to claim 9, wherein the vehicle component is embodied in the form of a hydraulic unit, preferably a hydraulic pump.

26. The holding device according to claim 10, wherein the vehicle component is embodied in the form of a hydraulic unit, preferably a hydraulic pump.

27. The holding device according to claim 12, wherein the vehicle component is embodied in the form of a hydraulic unit, preferably a hydraulic pump.
